(19) United States
(12) Patent Application Publication
(10) Pub. No.: US 2001/0033641 A1
(43) Pub. Date: Oct. 25, 2001

(54) Voice messaging system, method, and apparatus

(76) Inventor: Vu Tran Nguyen, San Francisco, CA (US)

Correspondence Address: John G. Flaim, Baker & McKenzie, 2001 Ross Avenue, Suite 2300, Dallas, TX, 75201, US

(21) Appl. No.: 09/764,198

(22) Filed: Jan. 17, 2001

Related U.S. Application Data
(60) Provisional application No. 60/177,076, filed on Jan. 19, 2000.

(51) Int. Cl. H04M 1/64; H04M 11/00

(52) U.S. Cl. 379/88.22; 379/88.13

(57) ABSTRACT

A voice messaging system and method are presented herein. A unique telephone number and extension are associated with each one of a plurality of subscribers. The telephone number is also associated with a remote access point of presence (RAPP). Messages are left for subscribers by establishing a phone call to the phone number associated therewith. The phone call is received with a RAPP. The RAPP receives the voice message, digitizes and packetizes the voice message, and transmits the message over a packet network to a store and forward messaging system. The store and forward messaging system stores the message for retrieval. The message can be retrieved by either telephone, a client computer, or a private branch exchange terminal.

### PRIORITY DATA

The present invention claims the priority of U.S. Provisional Application for Patent Ser. No. 60/177,076, entitled “System, Method, and Apparatus for Receiving and Transmitting Voice Messages Using Data Packet Networks”, filed on Jan. 19, 2000, by Vu Tran Nguyen, which is hereby incorporated by reference for all purposes.

### FIELD

The present invention is related to communications systems and more particularly to messaging systems.

### BACKGROUND

In voice communication networks, audio signals representing voice communications are typically transmitted using a circuit switched network. In a circuit switched network, a voice circuit is allocated and a connection between the communicating terminals is maintained for the duration of the voice transmission. At the completion of the voice transmission, the voice circuit is deallocated and the connection between the communication terminals is terminated.

An example of a circuit switched network includes the public switched telephone network (PSTN). However, many communication networks comprise a private branch exchange (PBX) connected to the PSTN. A PBX is customer premises equipment switch connected to the PSTN which serves any number of PBX terminals. The PBX terminals are usually located about a local area, such as an office, or corporate campus. The PBX and PBX terminals form a localized voice communication network, known as a PBX network, wherein communications between the PBX terminals are facilitated by the switching capabilities of the PBX. The PBX terminals access the PSTN via a connection between the PBX and the PSTN.

The PBX networks can permit both voice calls, as well as messaging, such as facsimile transmissions, and voicemail. Voicemail messages are transferred to a voicemail terminal for storage, and from the voicemail terminal to the recipient using the switching of the PBX network, in a manner similar to the transmission of synchronous communications. The voicemail terminal is known as a store-and-forward messaging system (SFMS). Facsimile transmissions are received at facsimile terminals.

Messaging over a switched network is inefficient for several reasons. The PBX network encodes communications using 64 kbps which is necessary to re-create 3 KHz analog voice and full duplexing. Therefore, the PBX network must provision each communication a separate circuit and 64 kbps channel which is held until the communication is complete. However, unlike synchronous communications, voice messaging only requires half-duplexing because it is one-way communication. Additionally, voice messaging also includes pauses and delays typically resulting in considerable capacity inefficiency.

In contrast, packet-switching slices the voice message into small packets. Once the voice message is sliced into small packets, each packet is transmitted to the receiving terminal using whichever path is open at the time. The packets are then assembled at the receiving terminal, to reconstruct the voice message. The use of a packet network is advantageous because the connections and voice circuits are not maintained for the entire length of the message.

Accordingly, it would advantageous if voice messages could be received and transmitted using data packet networks.

### SUMMARY

The present application discloses a system and method for transmitting a message. The message is received from a switched network at a remote access point of presence (RAPP). The RAPP routes the message over a packet network to a store and forward messaging system. The store and forward messaging system then stores the received message.

### BRIEF DESCRIPTION OF THE DRAWINGS

FIG. 1 is a block diagram of a voice messaging system in accordance with a first preferred embodiment;

FIG. 2 is a block diagram of a voice messaging system in accordance with a second preferred embodiment; and

FIG. 3 is a signal flow diagram describing the storage of a message;

FIG. 4 is a signal flow diagram describing the retrieval of the message from a telephone;

FIG. 5 is a signal flow diagram describing the retrieval of the message from a client terminal;

FIG. 6 is a signal flow diagram describing the retrieval of the message from a private branch exchange terminal; and

FIG. 7 is a block diagram of a representative hardware environment wherein the present invention can be practiced.

### DETAILED DESCRIPTION

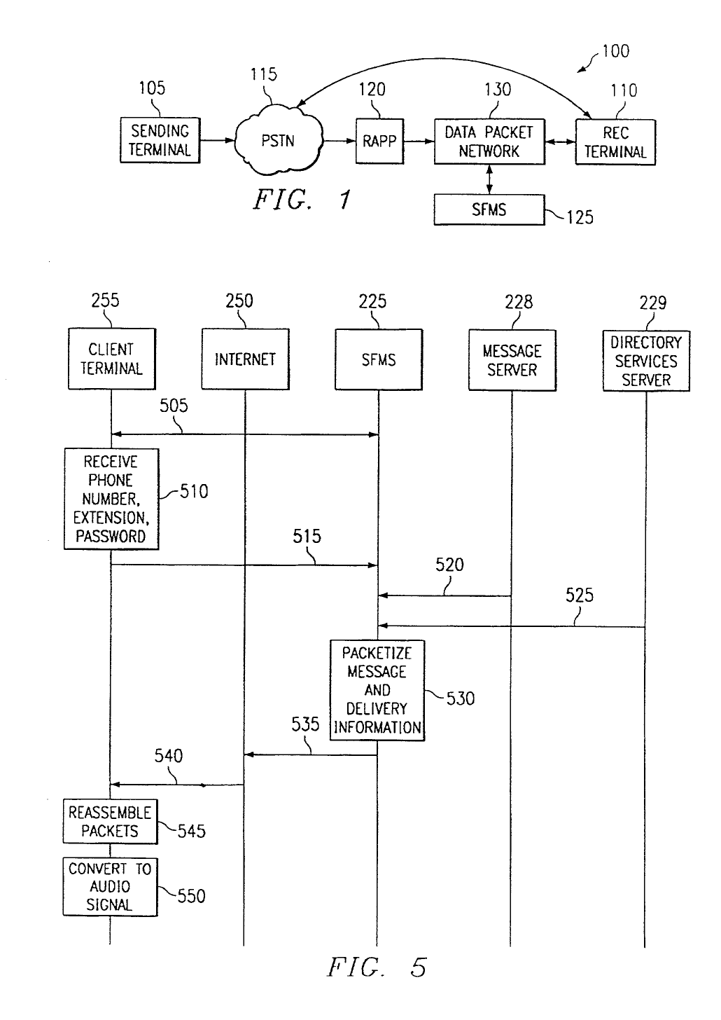

Referring now to FIG. 1, there is illustrated a block diagram of a voice messaging system, referenced generally by the numeric designation 100, for storing a message received from sending terminal 105 for retrieval by a retrieving terminal 110. The sending terminal 105 can comprise for example, a telephone, PBX terminal, or mobile station. The sending terminal 105 is linked to a switched network, such as public switched telephone network 115.

The PSTN 115 establishes a switched network connection between the sending terminal 105 and a Remote Access Point of Presence (RAPP) 120. The RAPP 120 receives the message and sends the message to a Store and Forward Messaging System (SFMS) 125 over a packet network 130. The SFMS 125 stores messages and the recipient information for any number of users.

The message is retrieved by the recipient at a recipient terminal 110. The recipient terminal 110 can either be linked to the PSTN 115 or packet network 130. Wherein the recipient terminal 110 is linked to the PSTN 115, the PSTN 115 establishes a connection to RAPP 120 which retrieves the message from the SFMS 125 over packet network 130. Alternatively, the retrieving terminal 110 can be directly connected to the packet network 130 and retrieve messages from the SFMS 125. The foregoing voice messaging network 100 stores messages for retrieval at a single location. The messages can be sent from any terminal connected to a PSTN 115 and can be retrieved by any terminal connected to a PSTN 115 or packet network 130.

It is noted that the PSTN 115 can service large coverage areas, thereby permitting messages to be received and retrieved from receiving terminals and retrieving terminals, almost anywhere in the world. For example, in the United States, the PSTN comprises a network of central offices, wherein each central office is associated with and serves a plurality of telephone terminal, such as the sending terminal 105. The central offices serving a particular locale, such as a city or geographical area are interconnected forming a local access transport area (LATA) served by a Local Exchange Carrier (LEC). Calls from one LATA to another LATA are handled by an Interexchange Carrier (IXC). Calls handled by IXCs are usually associated with access charges, often referred to as “long distance” charges.

It is desirable for the user to avoid incurrence of long distance charges. However, storage of messages at a single location is advantageous because hardware requirements are reduced. Therefore, messages are often transmitted over vast geographical distances to the SFMS 125. In order to minimize hardware requirements and alleviate long distance charges associated with transmitting messages to the SFMS 125, a network of RAPPs 120 are distributed throughout the coverage area of the PSTN 115, wherein a RAPP 120 is associated with each interLATA carrier. Accordingly, a PSTN 115 connection can be established between the retrieving terminal 105 and the RAPP 120 within the interLATA area of the recipient. The message is forwarded from the RAPP 120 to the SFMS 125 over a packet network.

The packet network 130 transports the message for the bulk of the distance to the SFMS 125. Use of the packet network 130 advantageously alleviates toll charges associated with the PSTN 115. Additionally, use of the packet network 130 results in more efficient utilization of bandwidth. The packet network 130 slices the voice message into small packets. Once the voice message is sliced into small packets, each packet is transmitted to the SFMS 125 using whichever path is open at the time. The packets are then assembled at the SFMS 125, to reconstruct the voice message. The use of a packet network is advantageous because the connections and voice circuits are not maintained for the duration of the message.

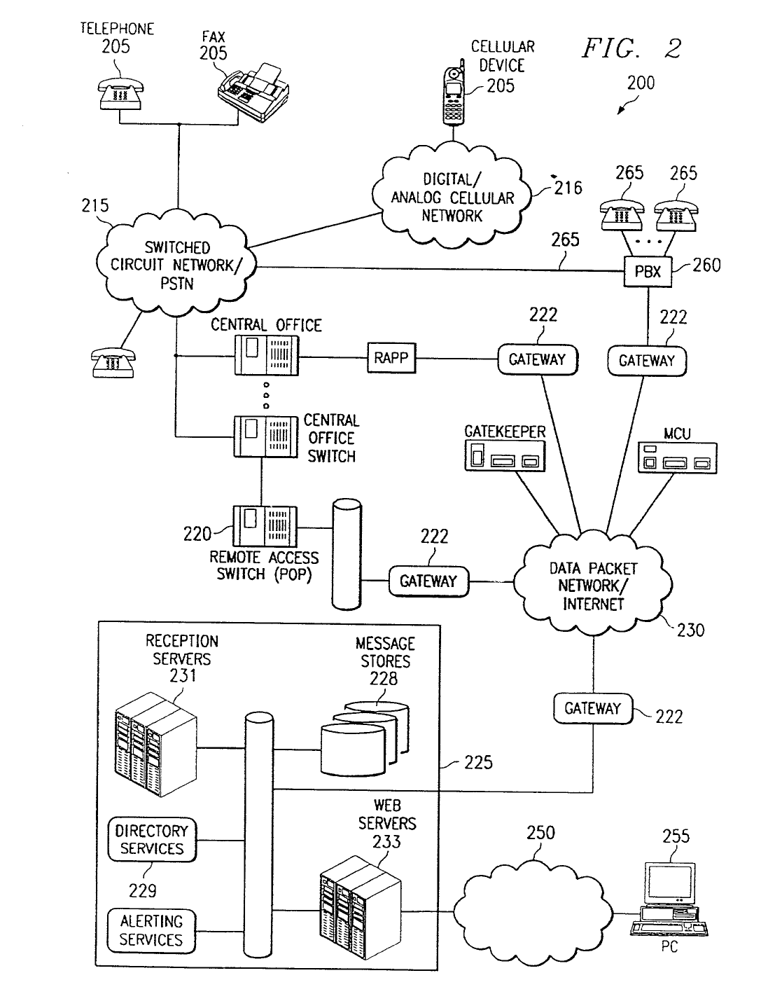

Referring now to FIG. 2, there is illustrated a block diagram describing a voice messaging system, referenced generally by the numeric designation 200. The voice messaging system 200 includes a switching network, PSTN 215 interfaced to a packet network 230. The PSTN 215 serves any number of telephones 205, facsimile machines 205, and cellular devices 205. The telephones 205 and facsimile machines 205 are directly connected to the PSTN 215. The cellular devices 205 are linked to the PSTN 215 via a cellular radio network 216.

Additionally, the PSTN 215 serves a network of RAPPs 220. The RAPPs 220 are spread sparsely about the PSTN 215 coverage area. The telephones 205, facsimile machines 205, cellular devices 205, and RAPPs 220 are each associated with a particular unique telephone number. The telephone number comprises a portion indicative of the geographic location of the terminal followed by additional unique numbers. For example, pursuant to the North American Numbering Plan, each telephone, facsimile machine, cellular device 205, and RAPP 220 can be associated with a telephone number comprising a three digit area code identifying the locale, followed by a seven digit phone number. The PSTN 215 selectively establishes switched network connections between any number of telephones 205, facsimile machines 205, cellular devices 205, and RAPPs 220 in a manner well known in the art.

Each RAPP 220 is also connected to the packet network 230 via a gateway 222. The RAPPs 220 serve as interfaces between the PSTN 215 and the packet network 230 and are equipped to convert switched network transmissions to packet network 230 transmissions, and vice versa. Additionally, the RAPPs 220 are equipped to address transmissions over the packet network to a centralized store and forward messaging system (SFMS) 225 connected to the packet network 230 via gateway 222. Also connected to the packet network 230 is a private branch exchange 260 via a gateway 222. The private branch exchange 260 is a private switch serving any number of PBX terminal 265. The PBX 260 is also connected to the PSTN 215 via a trunk connection 265.

The SFMS 225 is a voice messaging system which stores messages and delivery information for any number of subscribers in a message storage system 228 and directory services server 229, respectively. The delivery information includes, e.g., the recipient, sender information, time the message was left, and the length of the message.

Each subscriber is provided a telephone number and extension which as a combination are unique. The telephone number is the telephone number associated with a particular RAPP 220 in the subscriber's locale. The extension can be arbitrarily chosen to distinguish the particular subscriber from the other subscribers in the same locale. The telephone number and extension are received by the RAPP 220 from the PSTN 215 with the messages.

The SFMS 225 also includes an application server 231 and a web server 233. The application server 231 is equipped with application programs which provide access to the message stored in the message storage system 228 and the delivery information stored in the directory server 229. The web server 233 is also connected to the Internet 250 and allows Internet 250 access to the SFMS 225 by any suitably connected client computer 255.

The voice messaging system permits receipt of messages from any one of a plurality of telephones 205, facsimile machines 205, or cellular devices 205 connected to the PSTN 215. The messages are stored in the central SFMS 225 for retrieval by the recipient. The messages can be retrieved by the recipient by either any one of the plurality of telephones, cellular devices 205, PBX terminals 265, or from a suitably connected client computer 255.

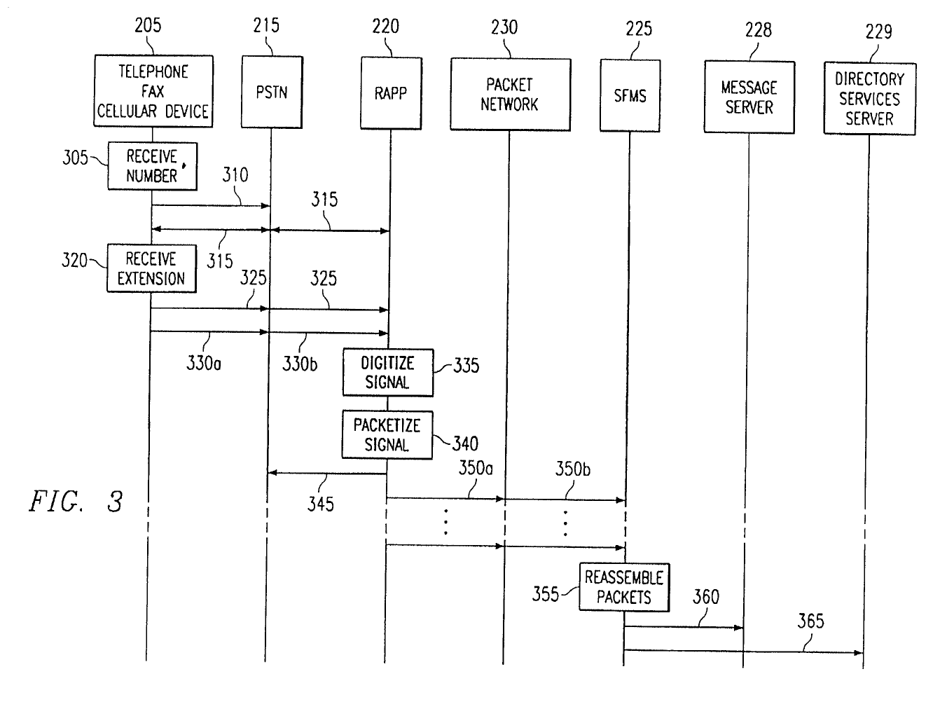

Referring now to FIG. 3, there is illustrated a signal flow diagram describing the delivery of a message. A user at telephone 205, FAX machine 205, or cellular phone 205 begins sending a message for a particular subscriber by dialing the telephone number associated with the particular subscriber which is received by telephone (action 305) and transmitted to the PSTN 215 (signal 310). The PSTN 215 establishes a telephone connection with the RAPP 220 associated with the receiving subscriber (signals 315). The user then dials the extension (action 320) associated with the subscriber which is received by the RAPP 220 (signal 325).

The RAPP 220 then receives the message from the telephone 205a, FAX machine 205b, or cellular device 205c. The message is transmitted over the PSTN 215 (signal 330a) to the RAPP 220 (signal 330b) as an analog signal. The RAPP 220 digitizes the analog signal (action 335), and then packetizes (step 340) the digitized signal for transmission over packet network 230 to SFMS 225. In a preferred embodiment, the packet network 230 can comprise either a private packet network, the Internet, and can include a wireless packet network.

The packets transmitted by the RAPP 220 comprise a header, payload, and trailer. The header includes control information such as synchronizing bits, the destination address, the origination address, and the length of the packet. Wherein the packet network 230 is the Internet, the SFMS 125 is associated with an Internet Protocol (IP) address and the IP address associated with the SFMS is included as the destination address. The payload includes the data to be transmitted. The trailer includes the end of packet indicator, as well as error correction and detection bits.

It is noted that during a phone connection, pursuant to Signaling System 7 (SS7) signaling, SS7 control messages are received at RAPP 220. The SS7 messages are related to the routing and quality of the PSTN 215 connection. However, the voice message transmitted by the user is forwarded over the packet network 230. Therefore SS7 messages consume bandwidth and are not related to the transmission over the packet network 230. To preserve bandwidth, the RAPP 220 transmits a message (signal 345) to the PSTN 215 causing the PSTN 215 to cease transmission of SS7 messages for the duration of the call.

The RAPP 220 transmits the voice message as data packets over the packet network 230 (signals 350a) via gateway 222. The packet network 230 routes the data packets to the SFMS 225 (signals 350b). The SFMS 225 receives the data packets transmitted from the packet network 230, and reassembles the digitized voice message (action 355). The digitized voice message also includes information indicating the dialed phone number and the dialed extension. As noted above, the dialed phone number and the dialed extension are indicative of the subscriber for whom to store the message.

Upon receiving a digitized voice message from RAPP 220, the SFMS 225 stores the message in a message server 228 (signal 360). The SFMS 225 also creates a record containing the dialed phone number and dialed extension, calling party number, time the message was received, and duration of the message for each message received. The records for each message received are stored in the directory services server (signal 365).

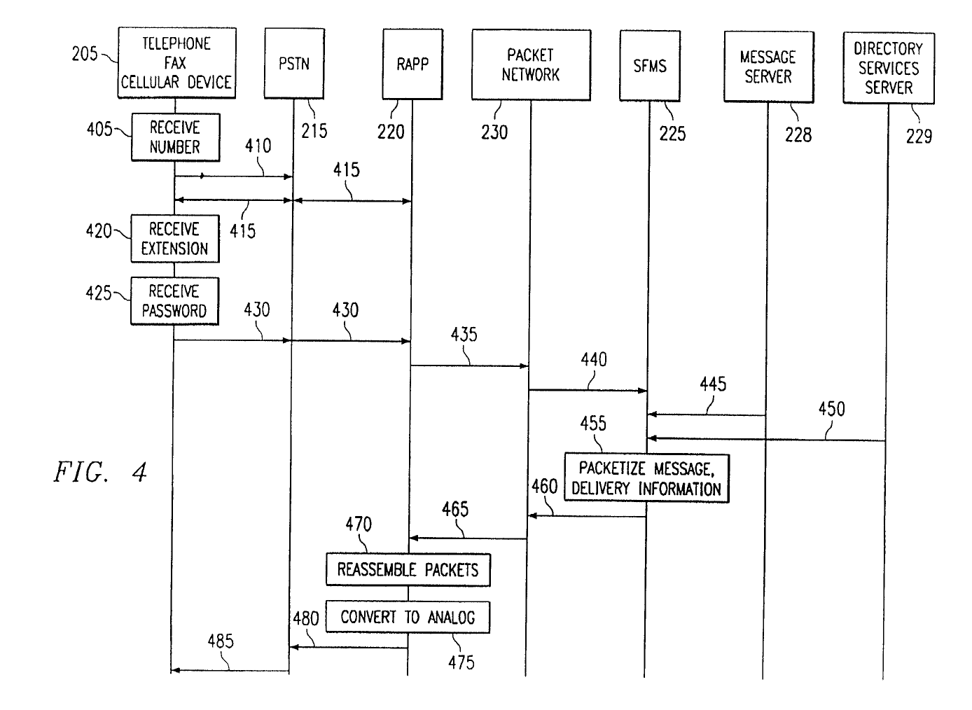

Referring now to FIG. 4, there is illustrated a block diagram describing the retrieval of messages stored in the SFMS 225 from a telephone 205, facsimile 205, or cellular device 205. Message retrieval is initiated by the subscriber dialing the phone number associated therewith (action 405) from the telephone 205, facsimile 205, or cellular device 205 which is transmitted to the PSTN 215 (signal 410). Responsive thereto, the PSTN 215 establishes a phone call between the telephone 205, facsimile machine 205, or cellular device 205 and the RAPP 220 (signals 415).

Upon completion of the phone call, a subscriber enters the extension associated with the subscriber (action 420) and a predetermined password (action 425) which are received by the RAPP 220 (signal 430). The RAPP 220 then transmits a request for messages stored for the subscriber over the packet network 230 (signal 435) to the SFMS 225 (signal 440).

Responsive to receiving the request for the messages, the SFMS 225 retrieves the messages associated with the subscriber from the message storage server 228 (signal 445) and the delivery information stored in the directory services server 229 (signal 450). The SFMS 225 then packetizes the messages and delivery information (action 455). The packets are addressed to the RAPP 220 dialed by the subscriber, using IP addressing, and transmitted over the packet network 230 (signal 460) to the RAPP 220 (signal 465). The RAPP 220 reassembles the received packets (action 470) and converts the message into an analog signal (action 475). The analog signal is then transmitted over the PSTN 215 (signal 480) to the telephone 205, facsimile 205, or cellular devices (signal 485).

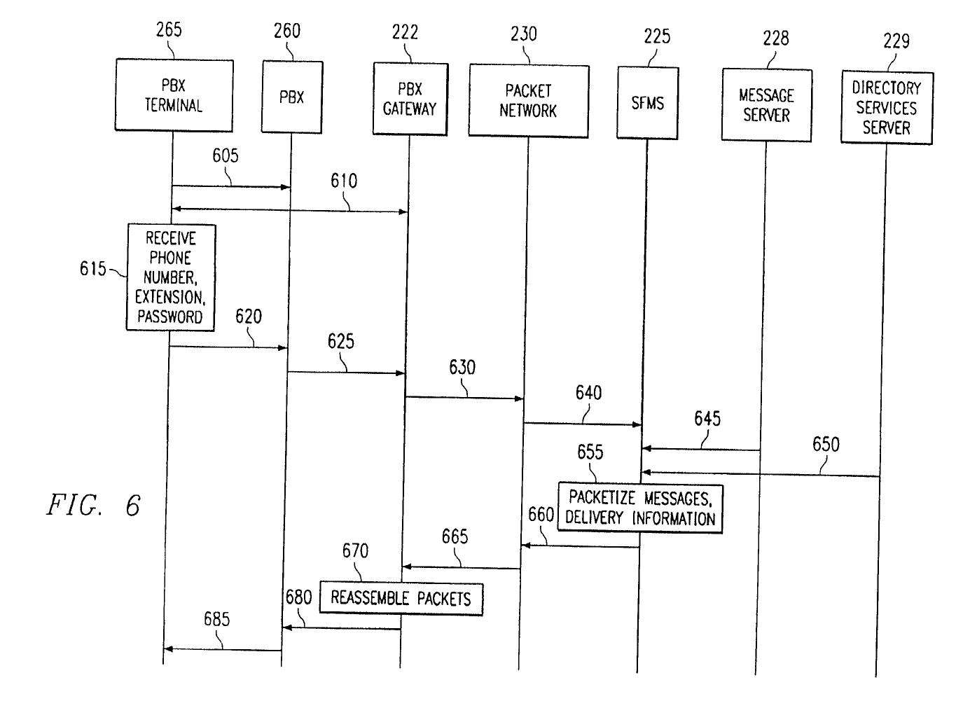

Referring now to FIG. 5, there is illustrated a signal flow diagram describing the retrieval of a message stored at the SFMS 225 from a client terminal 255. The client terminal 255 establishes a client/server connection with the SFMS 225 (signal 505) over the internet 250. Those skilled in the art will recognize that the client/server connections can be established by typing an address known as a web address into a browser program at the client terminal 255.

After establishment of the client/server connection between the client terminal 255 and the SFMS 225, the phone number, extension, and password are received at the client terminal 255 (action 510) and transmitted to the SFMS 225 (signal 515). Responsive to receiving the request for the messages, the SFMS 225 retrieves the messages associated the with subscriber from the message storage server 228 (signal 520) and the delivery information stored in the directory services server 229 (signal 525). The SFMS 225 then packetizes the messages and delivery information (action 530). The packets are addressed to the address associated with the client computer 255, using IP addressing, and transmitted over the packet network 230 (signal 535) to the client computer 255 (signal 540). The client computer 255 reassembles the received packets (action 545) to generate a digitized message. The client computer 255 then converts the digitized message into an audio signal (action 550).

Referring now to FIG. 6, there is illustrated a block diagram describing the retrieval of a message stored in the SFMS 225 from a PBX terminal 265. The PBX terminal 265 transmits a request for voicemail to the PBX 260 (signal 605). The PBX 260 establishes a PBX connection between a PBX gateway 222 and the PBX terminal 265 (signal 610). The subscriber phone number, extension number, and password are then received by the PBX terminal 265 (action 615) and transmitted over the PBX 260 (signal 620) to the PBX gateway 222 (signal 625). The PBX gateway 222 then transmits a request for messages stored for the subscriber over the packet network 230 (signal 630) to the SFMS 225 (signal 640).

Responsive to receiving the request for the messages, the SFMS 225 retrieves the messages associated with the subscriber from the message storage server 228 (signal 645) and the delivery information stored in the directory services server 229 (signal 650). The SFMS 225 then packetizes the messages and delivery information (action 655). The packets are addressed to the PBX gateway 222, using IP addressing, and transmitted over the packet network 230 (signal 660) to the RAPP 220 (signal 665). The PBX gateway 222 reassembles the received packets (action 670), thereby generating a digitized message. The digitized message is then transmitted over the PBX 260 (signal 680) to the PBX terminal 265 (signal 685).

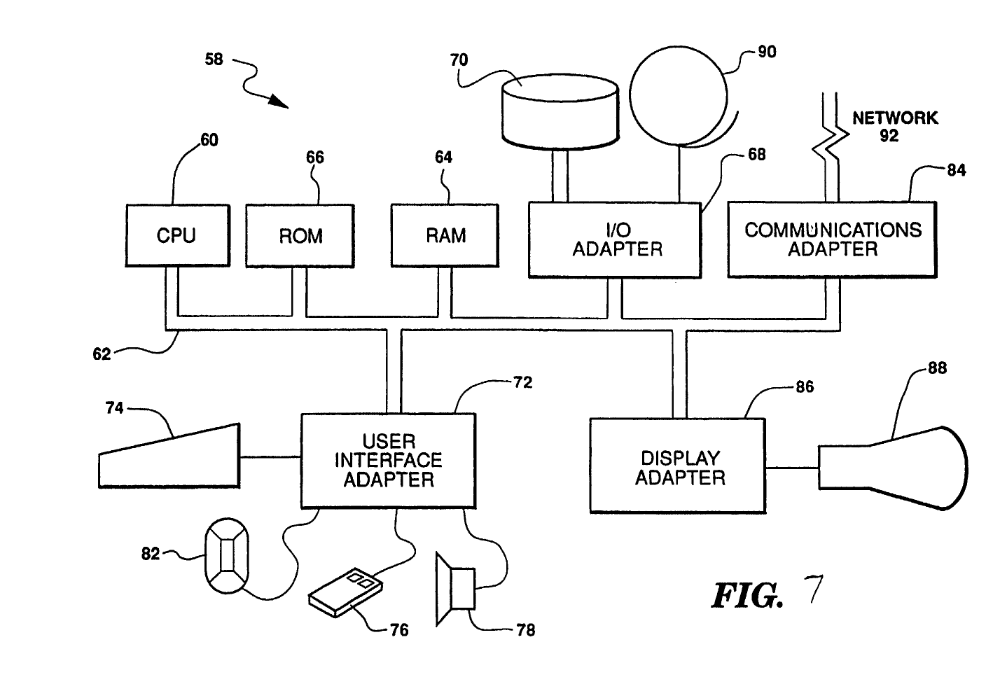

Referring now to FIG. 7, a representative hardware environment for practicing the present invention is depicted and illustrates a typical hardware configuration of a computer information handling system 58 in accordance with the subject invention, having at least one central processing unit (CPU) 60. CPU 60 is interconnected via system bus 12 to random access memory (RAM) 64, read only memory (ROM) 66, and input/output (I/O) adapter 68 for connecting peripheral devices such as disc units 70 and tape drives 90 to bus 62, user interface adapter 72 for connecting keyboard 74, mouse 76 having button 67, speaker 78, microphone 82, and/or other user interfaced devices such as a touch screen device (not shown) to bus 62, communication adapter 84 for connecting the information handling system to a data processing network 92, and display adapter 86 for connecting bus 62 to display device 88.

Although the invention has been described with a certain degree of particularity, it should be recognized that elements thereof may be altered by persons skilled in the art without departing from the spirit and scope of the invention. One of the embodiments of the invention can be implemented as sets of instructions resident in the random access memory 64 of one or more computer systems configured generally as described in FIG. 7. Until required by the computer system, the set of instructions may be stored in another computer readable memory, for example in a hard disk drive, or in a removable memory such as an optical disk for eventual use in a CD-ROM drive or a floppy disk for eventual use in a floppy disk drive. Further, the set of instructions can be stored in the memory of another computer and transmitted over a local area network or a wide area network, such as the Internet, when desired by the user. One skilled in the art would appreciate that the physical storage of the sets of instructions physically changes the medium upon which it is stored electrically, magnetically, or chemically so that the medium carries computer readable information. The invention is limited only by the following claims and their equivalents.

What is claimed is:

1. A method for transmitting a message, said method comprising:
receiving the message from a switched network at a first remote access point of presence; and
transmitting the message from the remote access point of presence over a packet network to a store and forward messaging system.

2. The method of claim 1, wherein receiving the message from the switched network further comprises:
receiving a telephone number and an extension number, wherein the telephone number is associated with the first remote access point of presence.

3. The method of claim 1, further comprising:
storing the message at the store and forward messaging system.

4. The method of claim 3, wherein storing the message further comprises:
storing the message in a message server; and
storing the telephone number and the extension in a directory services server.

5. The method of claim 1, wherein transmitting the message further comprises:
digitizing the message, thereby generating a digitized message; and
packetizing the digitized message.

6. The method of claim 1, further comprising:
sending a message from the remote access point of presence to the switched network, said message causing the switched network to cease transmission of data messages.

7. The method of claim 1, further comprising:
receiving a password at a second remote access point of presence;
transmitting a request for messages from the second remote access point of presence to the store and forward messaging system;
receiving the message from the store and forward messaging system at the second remote access point of presence; and
transmitting the message from the second remote access point of presence to the switched network.

8. The method of claim 1, further comprising:
establishing a client/server connection between the store and forward messaging system and a client computer;
receiving the telephone number, extension, and password from the client terminal; and
transmitting the message from the store and forward messaging system to the client computer.

9. The method of claim 1, further comprising:
receiving a password at a private branch exchange;
receiving the message from the store and forward messaging system at the private branch exchange; and
transmitting the message from the private branch exchange to a private branch exchange terminal.

10. A voice messaging system for transmitting a message, said system comprising:
a first remote access point of presence for receiving the message from a switched network; and
a store and forward messaging system for storing the message.

11. The voice messaging system of claim 10, wherein the first remote access point of presence receives a telephone number and an extension number, and wherein the telephone number is associated with the first remote access point of presence.

12. The voice messaging system of claim 11, wherein the store and forward message system further comprises:
a message server for storing the message; and
a directory services server for storing the telephone number and the extension.

13. The voice messaging system of claim 10, wherein the first remote access point of presence digitizes the message, thereby genera ting a digitized message and wherein the voice messaging system packetizes the digitized message.

14. The voice messaging system of claim 10, wherein the remote access point of presence sends a message to the switched network, said message causing the switched network to cease transmission of data messages.

15. The voice messaging system of claim 10, further comprising:
a second remote access point of presence for transmitting a request for messages to the store and forward messaging system, responsive to receiving a password; and
wherein the store and forward messaging system transmits the message to the second remote access point of presence.

16. The voice messaging system of claim 10, further comprising:
a web server for establishing a client/server connection between the store and forward messaging system and a client computer;
a graphical user interface for receiving the telephone number, extension, and password from the client terminal; and
an application server for transmitting the message to the client computer.

17. The voice messaging system of claim 10, further comprising:
a private branch exchange for receiving the password, wherein the private branch exchange forwards the password to the store and forward messaging system; and
a private branch exchange terminal for receiving the message from the private branch exchange; and
wherein the store and forward messaging system transmits the message to the private branch exchange responsive to receipt of the password.

18. The voice messaging system of claim 10, further comprising:
a packet network for routing the message from the first remote access point of presence to the store and forward messaging system.

19. The voice messaging system of claim 18, further comprising:
the switched network for transmitting the message to the first remote access point of presence.

20. A remote access point of presence for transmitting messages, said remote access point of presence comprising:
one or more processors;
memory storing a plurality of instructions therein, said plurality of instructions comprising means for:
receiving the message from a switched network at a first remote access point of presence; and
transmitting the message from the remote access point of presence over a packet network to a store and forward messaging system; and
a bus for coupling said one or more processors to said memory.

21. The remote access point of presence of claim 20, wherein the plurality of instructions further comprise means for:
digitizing the message, thereby generating a digitized message; and
packetizing the digitized message.

22. The remote access point of presence of claim 20, wherein the plurality of instructions further comprise means for:
sending a message from the remote access point of presence to the switched network, said message causing the switched network to cease transmission of data messages.
